(19) United States
(12) Patent Application Publication
(10) Pub. No.: US 2015/0261260 A1
(43) Pub. Date: Sep. 17, 2015

(54) METHOD OF WATER-PROOFING ELECTRONIC COMPONENTS

(71) Applicants: Royce J. Nicholas, San Diego, CA (US); Eren K. Yar, San Diego, CA (US)

(72) Inventors: Royce J. Nicholas, San Diego, CA (US); Eren K. Yar, San Diego, CA (US)

(21) Appl. No.: 14/210,743

(22) Filed: Mar. 14, 2014

(51) Int. Cl. G06F 1/16; B05D 3/04; B05D 1/18

(52) U.S. Cl. CPC G06F 1/1656; B05D 1/18; B05D 3/0493; B05D 3/0406

(57) ABSTRACT

A process for water-proofing devices from the inside out, the process is suited for application to completely fabricated electronic devices to enable them to be used with full functionalities in and under the water and in a variety of aquatic environments, shockproof and corrosion resistant. Multilayer technology fills empty spaces in the electronic device with a first layer of a hydrophobic medium like silicone and then a second layer of an anti-corrosive agent. Creating a vacuum removes air from the insulating mediums, slowly eliminating the vacuum to allow air to push the mediums into the device's internal voids, and then curing while preserving button functionality and patency of electronic pathways.

### CROSS-REFERENCE TO RELATED APPLICATIONS

This application claims the priority and benefit of co-pending U.S. Provisional Patent Application No. 61/798,166, filed Mar. 15, 2013 in the names of the same inventors, Royce J. Nicholas and Eren K. Yar.

### FIELD OF THE INVENTION

This invention is directed to a water-proofing method and more particularly, to a water-proofing method for electronic devices and components that can be used post-fabrication on pre-existing devices in addition to other uses.

### BACKGROUND

It is well-known that many exercisers enjoy listening to music while exercising as this can provide additional energy, therapy, stress relief, and make what could otherwise be monotonous, repetitious, and even boring more lively and enjoyable. This is especially the case for many solo sport athletes including distance runners, cyclists, and swimmers. Almost all athletes train alone sometimes and music can provide a sort of companionship and motivation. Today many athletes and music lovers prefer to compile their own databases of songs to choose from and to even pre-program the playlist on their electronic devices. Almost everyone has an MP3 player, cellular phone, Apple® iPod Shuffle®, Apple iPod Nano®, or other brand and model of portable music player.

Increasing awareness of the benefits of exercise and our national battle with obesity make the need to find some form of exercise that one can do and enjoy critical to a healthier and happier life. For many people with bad knees, stiff joints, other injuries, and those who don't like to get hot and sweat, water sports provide an ideal outlet for exercise.

Unfortunately, it is much less common to see a participant in water sports with a portable music player compared to their counterpart participant in land sports due to the susceptibility of typical electronic devices to water damage and short circuits. While runners and cyclists commonly benefit from portable music players the same is not yet true for swimmers, surfers, body-boarders, kite-boarders, water-skiers, snorkelers, rafters, and kayakers among others.

More generally, there is also a need for water-friendly, chemical-resilient versions of a variety of other electronic gadgets incorporating electronic components. This would enable people to use their favorite electronic gadgets more often without sacrificing their water-loving lifestyles. For example, it would be desirable to offer the ability to use fitness tracking devices (e.g. pedometers, Nike+ FuelBand®) in gym club pools, whirlpools, steam rooms, and saunas. Such fitness tracking devices can be described as electronic monitoring devices incorporating microprocessors, a digital display, and accelerometers, for detecting, storing, reporting, monitoring, uploading and downloading sport, fitness training, and activity data to the Internet, and communication with personal computers, regarding time, steps taken, calories burned, and distance. Fitness tracking devices may also include or be used with USB hardware and software and computer software for fitness. They may incorporate indicators that light up and change color or change another feature based on a wearer's cumulative activity level or other metric.

Likewise, the ability to genuinely waterproof medical and research electronic data-gathering devices would expand the domain of research possibilities. Activities and environments previously off-limits due to the likelihood of compromising medical data-gathering electronics would no longer be impractical. New data could be gathered from patients, athletes, and test subjects in new environments for greater insight. Such data-gathering medical, research, or other devices may incorporate cameras and other functionalities.

Another example of a desirable possibility is the ability to use a waterproofed version of the Apple® iPad™, Amazon® Kindle®, or other type of tablet computer or electronic reader in the bathtub, at the beach, at the pool, or on the boat without fear of risking catastrophic damage to the device.

More generally yet, it is desirable to provide better methods of water-proofing electronic devices. Many electronic devices come to a sad end due to spilled drinks, sudden rain, and other unexpected exposure to moisture.

To address these issues companies have created waterproof cases for electronic devices. The more effective variations of these cases are typically quite expensive and represent another purchase in addition to the product itself. The case shapes must be tailored for specific brands and models of products and are not one size fits all. Further, the cases add bulk and sometimes make it difficult to operate the product buttons and therefore to use the product effectively. More importantly, the cases do not usually hold up well over time. A rubbery waterproof case may prevent moisture from entering an electronic device initially by forming a single layer seal around the device. However, after regular and repeated use the seals at joints can wear out and leak resulting in the electronic device being permanently damaged. Finally, the cases typically do not hold up well under significant water pressure.

It would be desirable to have an electronic device that was completely waterproof in itself without need for purchase of an additional case adding to the product weight, volume, and cost. It would be even more desirable to provide a repeatable and scalable process for water-proofing many types of electronic devices to keep the cost affordable.

Several companies advertise water-resistant electronic gadgets. While these products may survive water being spilled or splashed onto them, or at most even falling in water, they are generally not designed or intended for extended use in the water including being subjected to underwater pressures. Most commonly only the exteriors of the devices are coated with a single layer that does not hold up over time. Further many of these devices are not resistant to all types of liquids and may be damaged by chlorine, salt, and other chemicals found in artificial and natural bodies of water.

It would be desirable to provide electronic devices not merely designed to handle water accidents but actually intended to be regularly used in and under water, including in both artificial (e.g. pools, hot tubs) and natural (e.g. oceans, lakes, rivers) bodies of water. The present invention meets this and other needs.

### SUMMARY OF THE INVENTION

This invention is based on multilayer technology that uses a proprietary process to water-proof any device from the inside. While reference art device cases and water resistant technologies focus on coating or protecting the outside of the device the methods described herein work to directly seal and protect the electronics from the inside, eliminating gaps and air pockets and providing a higher integrity product designed specifically for regular immersion in all varieties of aqueous environments.

Moreover, the proprietary process described herein has been refined to provide other practical benefits including shock proofing, to protect the user from short circuits and other electrical issues, plus corrosion resistance enabling the product to endure even the testiest aquatic environments such as salt water bodies and chemically treated public pools.

Another major advantage of the water-proofing process described herein is that it can be used on almost any existing device as is. Thus, the product-specific assembly process does not have to be re-engineered to accommodate this technology. This adaptability to work with existing products and manufacturing processes provides a huge cost savings while reducing the time to market of any particular water-proofed device. While the processes described herein may be tailored for specific devices and applications and could be accommodated in the device fabrication process this is not essential. The basic process is ready to go on existing products to offer greater versatility and increased product usage in a wider array of environments.

According to a first aspect of the present invention a method is provided for waterproofing one or more electronic components within an electronic device. The method includes covering an electronic device including at least one electronic component housed therein with a first hydrophobic medium. The method further involves placing the electronic device and the first hydrophobic medium together into a vacuum chamber, sealing the vacuum chamber, and reducing pressure inside the vacuum chamber to below atmospheric pressure. Subsequently, air is slowly let back inside the vacuum chamber. Further, the method includes removing the electronic device from the first hydrophobic medium.

According to a further aspect of the invention, the method includes the step of, prior to covering the electronic device with the first hydrophobic medium, applying a strip of adhesive tape over one or more lights of the electronic device, then applying grease to a power button of the electronic device while the lights are covered with the tape, and removing the tape.

According to an additional aspect of the present invention a waterproof electronic device including one or more electronic components waterproofed according to the method set forth in the preceding paragraph is provided.

According to another aspect of the present invention the method further includes maintaining a reduced pressure below atmospheric pressure inside the vacuum chamber until the first hydrophobic medium bubbles signifying the release of air. The gauge pressure inside the vacuum chamber may be reduced to between 10 to 30 inches of Mercury less than atmospheric pressure.

According to a further aspect of the present invention the method further includes, prior to removing the electronic device, stirring the first hydrophobic medium to release air and then repeating the steps of sealing the vacuum chamber, reducing pressure inside the vacuum chamber to below atmospheric pressure, and slowly letting air back inside the vacuum chamber, one or more times prior to removing the electronic device from the medium.

According to still another aspect of the present invention the method includes placing the electronic device into a second medium of an anti-corrosive agent. The electronic device may be kept in the second medium of the anti-corrosive agent for 30 to 120 minutes. The first hydrophobic medium and the second anti-corrosive medium may enter an external housing of the electronic device to surround one or more electronic components therein internally to the housing.

Prior to placing the electronic device into the second medium of anti-corrosive agent the method may also include inserting a cord into an externally accessible port of the electronic device in order to preserve functionality by clearing it out before the first hydrophobic medium cures and hardens. After inserting the cord, the method may further include placing the electronic device into a clamping device and pressing down on the buttons of the electronic device in one or more orientations while the cord is still inserted in the port.

According to an additional aspect of the present invention the first hydrophobic medium comprises silicone. The first hydrophobic medium may also include a curing agent. The first hydrophobic medium may further include an anti-corrosive agent. The first hydrophobic medium may further include a coloring agent. The weight fraction of the silicone in the first hydrophobic medium may be larger than the recommended weight fraction of the curing agent. Moreover, the weight fraction of the silicone in the first hydrophobic medium may be larger than the recommended weight fraction of the curing agent and the weight fraction of the curing agent in the first hydrophobic medium may be larger than the weight fraction of the anti-corrosive agent.

According to another aspect of the present invention the first hydrophobic medium comprises silicone together with polyethylene (PE) pellets and/or polytetrafluoroethylene (PTFE) powder.

According to yet another aspect of the present invention the first hydrophobic medium enters an external housing of the electronic device to surround one or more electronic components therein internally to the housing. Slowly letting air back inside the vacuum chamber pushes the first hydrophobic medium into the exterior housing of the electronic device. The electronic device may be selected from any standard, pre-fabricated model of portable music player, mobile phone, Smartphone, electronic reader, tablet computer, camera, fitness tracking device, medical data-gathering device, drug-dispensing device, or research data-gathering device.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a flowchart of a method for water-proofing an electronic device according to an embodiment of the present invention;

FIG. 2A is a cross-sectional view of an electronic device before being subjected to the water-proofing method;

FIG. 2B is a cross-sectional view of an electronic device after the first layer of a hydrophobic composition has been applied in accordance with the water-proofing method;

FIG. 2C is a cross-sectional view of an electronic device after the second layer of an anti-corrosive composition has been applied in accordance with the water-proofing method; and

FIG. 3 is a schematic illustrating several of the various elements that play a role in the water-proofing method.

FIG. 4A is a schematic illustrating a simple and typically preferred vacuum setup used in the water-proofing method.

FIG. 4B is a schematic illustrating a cleaner and more precise alternate vacuum setup of the water-proofing method.

FIG. 4C is a schematic illustrating an even cleaner alternative vacuum setup in which the waterproofing medium reaches the electronic devices via an external tube.

FIG. 5 is an overhead view of an electronic reader.

FIG. 6A is an overhead view of the bezel removed from the electronic reader.

FIG. 6B is an overhead view of the electronic reader with the bezel removed and with elastic bands placed around the greased buttons to hold them down and prevent them from becoming sticky.

FIG. 7 is a close-up view of tape placed over the LED lights of the electronic reader.

FIG. 8 is a close-up view of the cavity around the backside of the power button of the electronic reader.

### DETAILED DESCRIPTION OF THE INVENTION

Briefly and in general terms the multilayer waterproofing technology uses a proprietary, multi-step process to make electronics shockproof, waterproof, and corrosion-proof. The process is so effective that the finished products have demonstrated maintaining waterproof integrity at a pressure of 94.7 psi (in shallow water), or the equivalent of being 180 ft underwater. Additionally, the products are insulated to withstand up to 40,000 Volts.

While the process may be applied to electronic or non-electronic products at any stage of fabrication, a particular advantage of the process is that it can be used post-fabrication on pre-existing electronic products. The empty spaces inside existing, traditional, electronic, products makes them vulnerable to water damage. Even with a conventional case or water-resistant treatment on the outer surface if the case or coating layer leaks the device is usually destroyed. The process of the present invention focuses directly on this vulnerability that is the source of the problem and uses these same empty spaces surrounding the vital electronics to transform the product from at risk to immune. In a carefully engineered process the empty spaces are filled with protective layers of materials that encase the key electronic elements.

The first layer is a hydrophobic, thick, rubbery insulator that fills the interior of the device and forms a barrier around all of the sensitive electronic components. The objective is to fill the internal voids in the electronic device with a material that will neither dissolve in water nor allow water to pass through it. In addition to protection from water and other potentially damaging elements, the rubbery nature of the first layer also serves as a cushion to guard against drops, intense vibrations, and even the washing machine. Thus, desirable features of the first layer are that it is hydrophobic, waterproof, and shockproof.

The viscosity of the material used for the first layer should be low enough prior to curing that it can be poured. However, after curing the viscosity should increase sufficiently so that the material won't leak out when the device is subjected to gravity and other forces during athletic use. For example, prior to curing the viscosity may be in the range of 10,000 to 20,000 cps (centipoises, a unit of dynamic viscosity) at 25 degrees Celsius, and more particularly between 15,000 and 16,000 cps.

More specifically, by way of example but not of limitation, suitable materials for the first hydrophobic water-proofing layer include room temperature curing two part silicones. Materials available off the shelf that don't involve a curing agent may also be used, such as RTV silicones and/or certain greases.

Still other possible materials for one or more of the protective layers include tiny plastic polyethylene (PE) pellets or polytetrafluoroethylene (PTFE) powder as base filler and then adding silicone around the pellets or powder to seal any crevices. A further advantage of using hydrophobic powders or pellets is that they permit the retention of some air in the device. The retention of very small air pockets should permit some sound to travel through the device even if the internal electronics are waterproofed. In this manner sound functionalities, like speakers and microphones, of some electronic devices (e.g. smartphones) could be preserved despite water-proofing. Yet another advantage of using hydrophobic powders or pellets is that the weight gained from water-proofing an electronic device may be lower than when the powders or pellets are not used in water-proofing the device.

Further examples of first layer materials or constituents of compositions include thermoplastics and polyurethanes. Catalysts and additives can also be added for various purposes including adjustment of curing time. For example, epoxies and other adhesives or glues may be added.

While providing a second water-proofing barrier, a primary benefit of the second layer is to protect the device from corrosion caused by threatening chemicals in environments such as oceans, pools, baths, and hot tubs. Exemplary anti-corrosive materials that may be used for the second layer are petroleum distillates. The anti-corrosion material is preferably petroleum based appearing like a motor oil or grease. It should adhere at least to any metal surface and in this application to the inner metal or metal-like surface of the electronic device. In this manner the second layer fills any voids in the electronic device that remain and are not already covered by the first hydrophobic layer. To cover non-metallic surfaces a second layer material having a higher viscosity after curing should be selected.

In other variations more than two layers may be used including three or more layers with a combination of (i) pellets or powders, (ii) silicone-based or silicone-like hydrophobic layer, and (iii) an anti-corrosive layer. Any combination of these materials could also be mixed in a single layer.

As applied to a portable music player, the first layer covers the electronic components inside the device and is situated underneath the housing and external button or buttons (e.g. on/off toggle switch, play/pause, next track, back track, etc.) used to operate the device. The second layer is directly outside and over the first layer and also indirectly over the electronic components and inside the housing and external button or buttons thereon used for device operation.

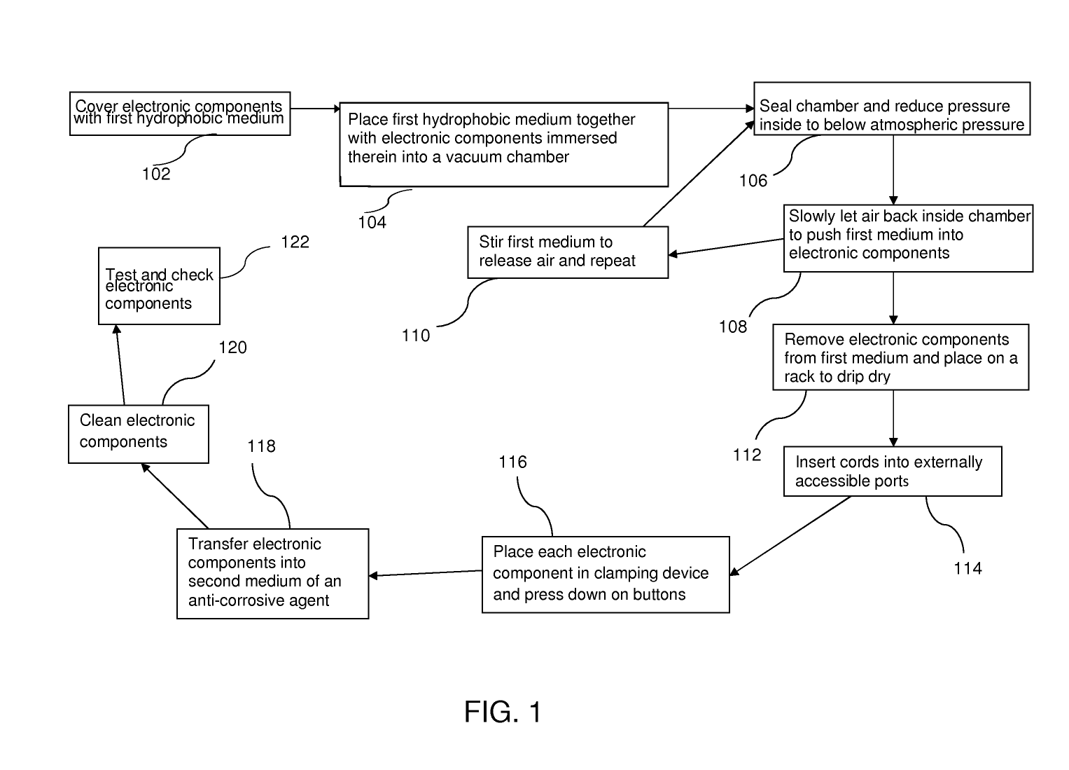

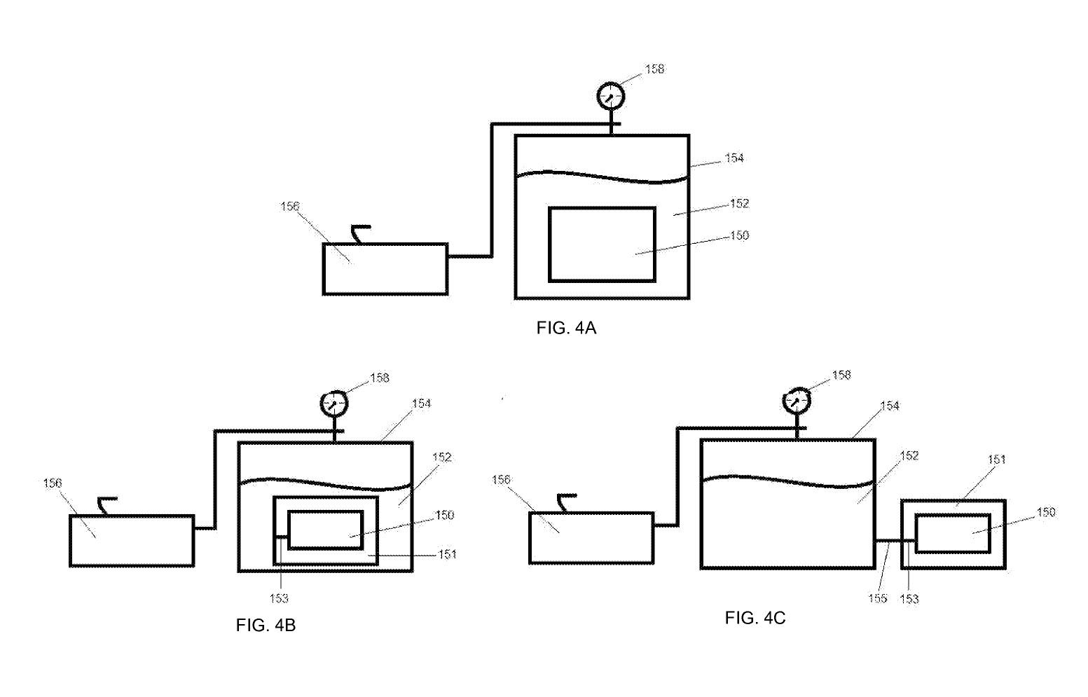

With reference to the drawings, FIG. 1 illustrates a flowchart of a method for water-proofing an electronic device according to an embodiment of the present invention. Steps can be added or deleted without departing from the basic inventive concept. First, as shown in box 102, cover the electronic components with a first hydrophobic medium. Typically the electronic components are contained within an exterior housing of an electronic device such as a portable music player, mobile phone, smart phone, portable reader, or tablet computer. In these cases references to covering or immersing the electronic components refers to covering or immersing the electronic device within which these components are contained. This can be accomplished by pouring the first hydrophobic medium over the electronic components in a bucket or dipping the electronic components into a container filled with the first hydrophobic medium. It is faster and thus usually preferable to simply immerse the electronic components in a first hydrophobic medium 152, however, a cleaner alternative setup is to enclose the electronic devices 150 in a molded housing 151 or capsule with opening(s) such that the flow of a first hydrophobic medium 152 into the electronic devices 150 is more controlled. FIG. 4B and FIG. 4C illustrate possible embodiments of this cleaner alternative setup.

Next, as shown in box 104, place the first hydrophobic medium together with the electronic components immersed therein into a vacuum chamber. Then, as shown in box 106, seal the vacuum chamber and reduce the pressure inside to below atmospheric pressure. For example, the gauge pressure inside the vacuum chamber may be reduced to between −20 to −30 inches of Mercury. More specifically, taking the gauge pressure inside the vacuum chamber down to around 29 inches of Mercury less than atmospheric pressure, approximating a perfect vacuum, has proven successful. The gauge pressure inside the chamber should be reduced well enough below atmospheric pressure that the medium bubbles for some time to release a substantial portion of the air within. The objective is to allow the medium to bubble long enough that the maximum amount of air within the medium that is going to leave has a chance to leave.

As shown in box 108, slowly let air back inside the chamber to push the first medium through the housing of the electronic device and into contact with the electronic components. As shown in box 110, optionally, at this point stir the first medium to release additional air and re-introduce the vacuum to ensure the medium has been sufficiently pushed into the electronic device to encase the electronic components therein.

With reference to box 112, remove the electronic components from the first medium and place them on a rack to drip dry. In some embodiments this step can be modified or even skipped. The drip dry rack is not essential but in some cases can save time and material costs. Other drying methods are possible including cleaning off the outside of the components by hand or using a quick dry medium that requires no further actions.

The objective of drying the components on a rack is to allow the medium to drip off of the outer surfaces of the device but not from within the device. The drying rack and electronic device orientation thereon should be chosen accordingly for this purpose. For example, the headphone jack or other ports should be facing up when the device is on the rack so that the internal medium does not drip out. This detail is especially helpful when a lower viscosity medium is used.

As in box 114, insert one or more cords into any externally accessible ports of the electronic device. This step is important to preserve the patency or openness of electrical connection pathways. If this step is skipped residual medium could cure and harden inside the electrical gateways and interfere with necessary connections.

Likewise, the box 116 instruction to place each electronic component in a clamping device and press down on the buttons can be important for some types of devices to preserve button functionality. In other types of devices this step is not necessary and may be skipped. When applicable, the first hydrophobic medium can increase the stiffness of buttons so it can sometimes be helpful to use the buttons promptly after treatment before the medium cures and hardens. Further, in some types of electronic devices one should be careful to press down on the buttons while any cords are still inside electrical ports (e.g. a headphone jack) to prevent any medium residue that gets squeezed out when the buttons are pressed down from moving into the ports. Maintaining the patency of the port channels preserves electronic communication functionalities.

In some embodiments, the electronic components may be clamped to press down on the buttons before they are initially covered in waterproofing medium or pre-medium, pre-vacuum, before step 102 and potentially stay clamped until the waterproofing medium has cured.

Next, per box 118 the electronic components can be transferred into a second medium of an anti-corrosive agent. This ensures they are not merely water-proof but can tolerate all the chemicals and elements commonly found in both artificial and natural aquatic environments. Finally the electronic components can be cleaned as in box 120 and then tested for performance integrity as in box 122.

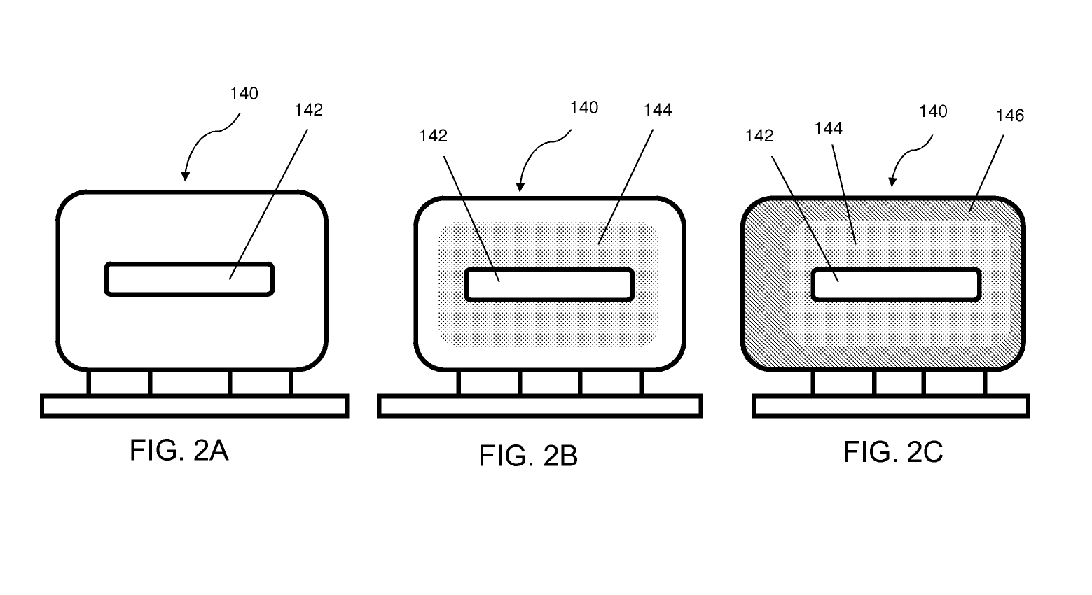

With reference to FIGS. 2A-2C, cross-sections are shown of an exemplary electronic device 140 before water-proofing treatment (FIG. 2A), after treatment with the first hydrophobic medium (FIG. 2B), and after further treatment with the second anti-corrosive agent (FIG. 2C). The cross-sections illustrate how the water-proofing of the electronic components 142 occurs on the interior of the electronic device 140, beneath the external housing 148. The first hydrophobic medium forms a first layer 144 around the electronic components and the second anti-corrosive agent forms a second layer 146 outside the first layer beneath the external housing. It is foreseeable that additional layers could also be added for particular applications without departing from the basic inventive concept.

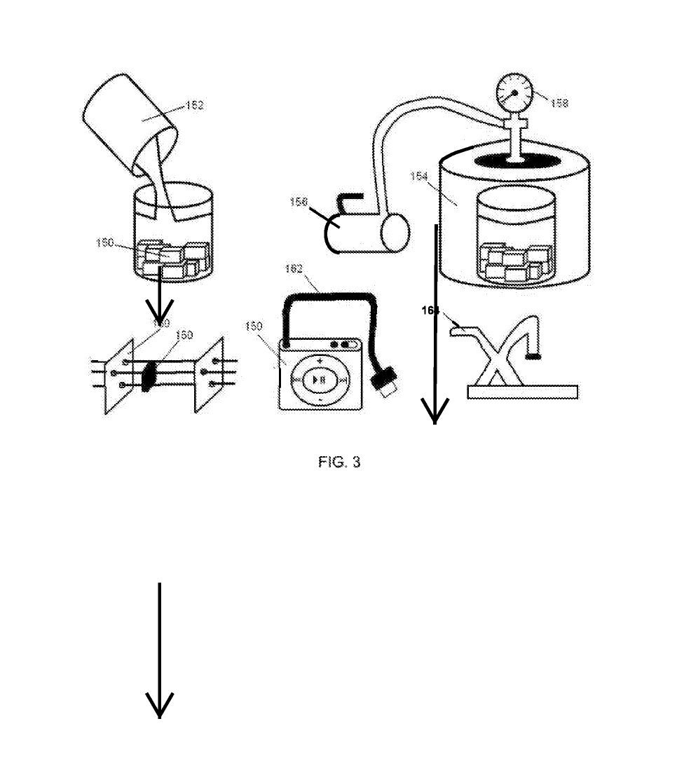

FIG. 3 is a schematic illustrating several of the elements that play a part in the water-proofing method of the present invention. Included is a plurality of electronic devices 150 in a bucket being covered with the first hydrophobic medium 152. This bucket including the electronic devices immersed in medium can be placed into the vacuum chamber 154. The vacuum chamber can be an ordinary tank or cooking pot that can be securely sealed and attached to a vacuum motor 156 to let air in and out and create the vacuum. Reduction of pressure inside the vacuum chamber should be measurable on a pressure gauge 158 attached to the chamber to ensure a vacuum is created and maintained. The pressure gauge should also be monitored to ensure air is allowed to re-enter only very slowly to avoid air moving in too fast and cutting through the medium to create air pockets inside crevices of the electrical device.

Also shown in FIG. 3 is the optional drip dry rack 160 where the electronic devices may be placed after treatment with the first medium and prior to treatment with the anti-corrosive agent (not shown). An exemplary electronic device of a popular portable music player is shown with a USB cord 162 plugged into the headphone jack of the device to ensure it is clear of residual medium that could compromise electrical connections and performance. Finally, an optional button press 164 is shown which is where the buttons on some types of electronic devices are pressed by clamping down on the press. Clamping may be done before the electronic components are introduced to the waterproofing medium and maintained throughout the process or after removal from the medium and the vacuum. This ensures the buttons do not become so stiff and unusable. When clamping occurs after removal of the electronic components from the medium it should generally be performed while any cords are still inserted in the jack(s). Depending upon the type of electronic device, the chemicals used for the waterproofing mediums, and the process conditions, sometimes electronic devices can be waterproofed according to the methods of the present invention without need for the button press.

With reference to FIGS. 4A-4C, slightly differing vacuum filling setups are shown as related to the waterproofing process. FIG. 4A shows the simplest vacuum filling setup which is explained in detail in the following examples of the invention. FIG. 4B shows a cleaner alternative setup in which the electronic devices 150 are enclosed in a molded housing 151 or capsule with one or more openings 153 such that the flow of a first hydrophobic medium 152 into the electronic devices 150 is more controlled. FIG. 4C shows an even cleaner embodiment of the vacuum filling process in which the molded housing 151 and enclosed electronic devices 150 are connected to the first hydrophobic medium 152 via an external tube 155. This external tube 155 allows for passage of the first hydrophobic medium into the electronic device upon letting air back into the vacuum chamber.

### EXAMPLES OF THE INVENTION

A general vacuum process used to carefully apply a waterproofing layer in accordance with a process of the present invention, is as follows:

1. Prepare the waterproofing medium by mixing together a designated amount of hydrophobic, liquid-like substances with water repellent and corrosion deterring qualities. This mixture can change based on the product that is being waterproofed.

Typically there is a short window of time (prior to curing) allowed to use the medium before it becomes more solid than liquid.

2. Place the products to be waterproofed within the waterproofing medium. A clean bucket can be used to hold both the medium and the products. Either the products can be placed in the bucket first and the medium poured over the products or the medium can be poured into the bucket first and the products pushed or dipped into the medium. Another variation is to forgo the bucket and place the medium and products directly into the vacuum chamber. Regardless of which variation of immersing the products in the medium is followed, it is good practice to ensure that there is sufficient medium above the highest point of the products. Generally the amount of medium should be about twice as high as the height of the highest product.

3. Place the product filled medium into a vacuum chamber and seal the vacuum chamber. For example, the vacuum chamber can simply be a securely sealed metal cooking pot connected to a vacuum pump or motor.

4. Remove air from the vacuum chamber, creating less than atmospheric

pressure inside the chamber. For example, with an electric vacuum pump take the gauge pressure inside the chamber down to around 29 in Hg (inches of Mercury) below atmospheric pressure, approaching a near perfect vacuum. The lower the gauge pressure within the vacuum chamber relative to atmospheric pressure outside the chamber, the stronger the force of the air returning into the vacuum chamber will be. It is this force that pushes the waterproofing medium into the devices. In some cases when less force is desired to avoid covering sensitive areas of the devices, such as screen displays, the vacuum pressure should be reduced to a lesser extent but still below atmospheric pressure.

Turning on the vacuum pump for a period of time will evacuate the chamber of air creating a vacuum. The more air that is removed, the greater the vacuum created, and the stronger the force pushing medium into the products when air is let back into the chamber. When the vacuum is created it will appear that the medium is boiling as bubbles are seen on the surface of the medium signifying the release of air from within the medium. This is the objective of the vacuum process as the more air released from the medium, the less likely it is that there will be air pockets within the product. Less air pockets in the product means superior waterproofing. However, in some variations (particularly those using hydrophobic powders or pellets in one of the layers) it may be desirable to leave some very small air pockets to allow sound travel through the device for speakers and microphones. To clarify, this escape of air and bubbling occurs at room temperature and the medium does not change state from liquid to gas as the traditional use of the word boiling implies.

5. Break the vacuum seal by gradually allowing air back into the chamber.

For example, if a metal pot or tank is used there should be valves above it that can be opened to let air back in. The pressure should be monitored while letting air back in to ensure the pressure rises only very slowly. This will smoothly push the medium into the empty spaces interior to the product. However, if the air is let into the chamber too quickly, some of the air will likely cut through the medium and enter the product creating the air pockets sought to be avoided.

6. After the chamber has returned to atmospheric pressure, remove the product from the medium.

Other product specific steps may follow the first vacuum process.

In order to determine the efficacy of the present invention it has been realized and tested on a specific product, namely to waterproof Apple® iPod Shuffle® and Nano® products. More specifically, the process has been realized on third and fourth generation Shuffle®'s and sixth and seventh generation Nano®'s.

### Specific Example Embodiment #1

### Waterproofing Process Applied to Fourth Generation Apple® iPod® Shuffle®

1. Prepare the waterproofing medium by mixing ingredients A, B, and X.

Material A represents a low viscosity silicone. Material B represents a curing agent that causes the mixture to solidify. More specifically, Material B is a tin catalyst primarily used for curing silicone. Material X represents an anti-corrosive agent. These ingredients can change in terms of both the actual ingredients used and the relative quantities by weight.

2. Place the iPod® Shuffle® music players face down in a bucket or other fillable container. The devices may be stacked on top of each other to form multiple layers in order to treat more products at the same time.

3. Pour the waterproofing medium over the iPod® Shuffle® devices until enough medium has been added that the height of medium is around twice the height of the highest iPod® Shuffle®. All of the devices should be completely covered.

4. Place the bucket full of the iPod® Shuffle® devices covered in medium into the vacuum chamber.

5. Turn on the fan to vent the exhaust air away from the operator.

6. Put the lid on top of the vacuum chamber, ensuring the gasket is touching the top rim of the chamber all the way around the rim for a secure seal.

7. Ensure that the air flow valve is closed so that air outside the chamber cannot enter the chamber.

8. Turn on the vacuum pump.

9. Wait at least a couple minutes, allowing the pressure gauge of the vacuum chamber to reach −29 in Hg (inches of Mercury) or 29 in Hg below atmospheric pressure. The medium should bubble as it releases air.

10. Turn off the vacuum pump.

11. Slowly turn the air flow valve towards open until you can hear, see, or feel the air flowing back into the chamber. When the gauge pressure in the chamber is reduced to −29 in Hg air should be reintroduced slowly enough so that the chamber regains pressure at a rate between 0.161 in Hg per second and 0.483 in Hg per second. An average pressure equalization rate of 0.294 inches of mercury per second corresponding to a pressure increase of 1 inch of mercury over 3.4 seconds has been shown effective.

12. Wait for the pressure in the chamber to completely equalize and reach atmospheric pressure.

13. Remove the lid from the vacuum chamber.

14. Poke through the medium and mix it a bit in order to help release more air bubbles.

15. Repeat steps 6-13 so that the products have gone through the vacuuming process at least twice.

16. Remove the bucket from the vacuum chamber.

17. Remove the iPod® Shuffle® devices from the bucket and the waterproofing medium therein.

18. Place the iPod® Shuffle® devices on a drip rack to remove the majority of the excess external waterproofing medium.

19. One at a time, take each iPod® Shuffle® device from the drip rack and insert a USB or other cord into the headphone jack or port. Plugging the cord into the headphone jack ensures that all of the waterproofing medium is out of the cavity and does not return to or get squeezed into the cavity while the buttons are being pressed down in the next step. It is undesirable to permit waterproofing medium to harden inside the headphone jack cavity as this could interfere with the sound quality. Inserting a cord into the jack cavity at an early stage before curing prevents this.

20. Place each iPod® Shuffle® device into the button press and clamp down the press.

21. Wait the allotted amount of time to achieve optimal button stiffness. This amount of time can change based on the days conditions, however a good starting point is to clamp down for around 30 seconds. During the waterproofing process the buttons become stiffer than on a regular iPod Shuffle®. However, they should be just as responsive and can be loosened up by pressing down on them and using them regularly. Using the button press to depress the buttons promptly after removal from the medium and before curing minimizes this issue and preserves the functionality of the buttons.

22. Unclamp the button press and rotate each iPod® Shuffle® 180 degrees in order to evenly press the buttons on all sides if the button press does not have a self-leveling head: if a swivel-head is used to press the buttons evenly, this is not necessary. This removes any angle the press may have in relation to the iPod® Shuffle®.

23. Clamp each iPod® Shuffle® again for a second time in its new orientation.

24. Remove each iPod® Shuffle® from the button press and remove the cord from the headphone jack.

25. Check the force required to activate each of the 5 buttons of the iPod® Shuffle® device. This can be done by pressing the tip of the force gauge vertically down onto the button until the LED light turns green and then immediately reading the gauge.

26. If the iPod® Shuffle® devices pass the button stiffness test, place them in a basket together.

27. Lower the basket into a tank filled with an anti-corrosive agent and wait at least one hour.

28. Remove the basket of iPod® Shuffle® devices from the tank of anti-corrosive agent.

29. Clean the iPod® Shuffle® devices and put them in a box to be tested, checked, and packaged for sale.

For the materials A, B, and X and their relative weight ratios in Step 1 of the process described above this can change depending upon the particular product treated, target characteristics, and materials available. Generally speaking, Material A represents the amount of a hydrophobic agent that has a sufficiently low viscosity at room temperature (and prior to curing) that it can be readily poured. In the example above Material A is a room temperature curing silicone. Silicone has been found to be the most useful waterproofing material but it is definitely not the only possibility.

Material B represents a curing agent that causes the mixture to solidify. More specifically, Material B is a tin catalyst primarily used for curing silicone. The chemical family is organopolysiloxane. The other way to cure silicone is to use platinum based catalysts but this can be more expensive. Tin catalysts create a higher tensile strength.

Material X represents an anti-corrosive agent. This combination of materials creates the first layer. An anti-corrosive agent is used again in Step 27 to create the second layer.

Thus, the anti-corrosive agent can be used both as a component of the first waterproof/shockproof layer and also applied separately as a subsequent additional layer to further coat the devices after they have been initially waterproofed. Different ratios and compounds may be used for different devices including, for example, the iPod Nano®, iPhone®, and Amazon® Kindle®, among many other possibilities of portable music players, smartphones, cell phones, tablets, and other portable electronic devices.

The ratio of the materials A:B:X in the combination first layer can be tailored to specific processes and the time needed to work with the same batch of material before it hardens. For example, it is favorable to adjust the ratio as necessary so that the first layer medium has a lower viscosity to start but then hardens after the device has been filled. With the ratio used for the fourth generation Apple iPod® it takes a day or two for the medium to completely harden. This time frame permits use of the same batch of mix for over 8 hours before it is too solid to fill devices.

With a greater proportion of curing agent one may have only an hour to use the medium before it hardens too much to act like a liquid. It is important that the first hydrophobic medium can act like a liquid so that it is easily received in all internal crevices of the devices to encase or safeguard the electronics. Vacuum pressure facilitates this but the medium must also be sufficiently liquid like and have a sufficiently low viscosity to start.

In the iPod Shuffle® device an alternative to the silicone mentioned previously, is a combination of silicone and grease mixed together. While these products will work in the vacuum they do not fill the devices as easily since their viscosities are higher. However, these types of silicone have proved useful in the vacuum to fill the iPod Nano®. It is contemplated that materials other than silicone based materials may also be used for the first waterproofing medium consistent with the principles of the present invention.

### Specific Example Embodiment #2

### Waterproofing Process Applied to Amazon® Kindle® Paperwhite® Electronic Reader

1. Prepare waterproofing medium by mixing the following ingredients. The actual amount needed is based on the quantity of electronic readers that are being waterproofed. These ingredients and the relative proportions are adjustable to produce the best results given the particular product and environmental conditions (temperature, pressure, humidity, equipment):

i. A (a low viscosity silicone)

ii. B (a curing agent)

iii. W (a coloring agent)

iv. X (an anti-corrosive agent)

2. Remove the bezel that borders the screen of the Kindle® brand electronic reader by inserting a thin tool underneath it and lifting up.

3. Place a strip of adhesive tape, or other protective material, over the LED lights along the bottom of the screen in order to protect them from grease applied in the next step.

4. Grease the power button by rubbing a dielectric grease into the power button with the goal of grease filling the cavity 220 behind the power button 210. This step helps retain the tactile feel of the power button, keeping it from stiffening.

5. Remove the protective tape from the LEDs.

6. Place the Kindle® brand electronic readers face up in a container. It is okay to stack them on top of each other in multiple layers. It is advised however to use spacers between each pair of adjacent electronic readers so the waterproofing medium can travel freely to each one.

7. Pour the waterproofing medium over the electronic readers. The top

surface of the medium should be twice the height of the highest one to ensure that air does not reach the electronic readers but instead there is enough waterproofing medium above them at all times.

8. Place the container of electronic readers and waterproofing medium into the vacuum chamber.

9. Put the lid on top of the vacuum chamber, ensuring the gasket is touching the top rim of the chamber all the way around the rim.

10. Ensure that the air flow valve is closed so that air outside the chamber cannot enter the chamber.

11. Turn on the vacuum pump.

12. Wait at least a couple minutes, allowing the vacuum to reach at least −29 in Hg as read on the pressure gauge.

13. Turn off the vacuum pump.

14. Slowly turn the air flow valve towards open until you can hear, see or feel the air flowing back into the chamber.

15. Wait for the pressure in the chamber to completely equalize and reach atmospheric pressure.

16. Remove the lid from the vacuum chamber.

17. Poke through the medium and ensure that the electronic reader is against the bottom of the container. Also ensure that any air pockets or bubbles are broken and the space replaced with waterproofing medium.

18. Repeat steps 6-14 at least 2 times such that the products have gone through the vacuuming process at least 3 times in total, or the top surface of the waterproofing medium no longer rises during vacuuming.

19. Remove the container from the vacuum chamber.

20. Remove the electronic readers from the container.

21. Insert a Micro USB plug into the female Micro USB port of the electronic readers.

22. Replace the bezels by pressing them down in their original position on each Kindle® brand electronic reader such that the bezel is flush with the edge of the outer body of the reader. The Kindle® brand electronic readers should look as they originally did.

23. Remove the excess waterproofing medium from the exterior of the electronic readers. This can simply be done by wiping with a cloth or paper towel.

24. Press the power button at least 10 times to ensure easy movement of the button.

25. Remove the Micro USB plug from the electronic readers once the waterproofing medium has started to solidify, approximately 30 minutes later.

26. Place electronic readers in a basket.

27. Lower the basket into a tank of corrosion preventative liquid such that the electronic reader(s) is/are fully submerged.

28. Wait at least one hour.

29. Remove the basket from the corrosion prevention coating tank.

30. Clean the electronic readers completely and put them in the box to be tested, checked and packaged for sale.

In step 1 above the W represents a coloring agent. It is advantageous that the coloring agent selected mixes well with the other ingredients and dries relatively quickly. This W is an additional ingredient to those used in the electronic music player waterproofing process. The addition of W to the waterproofing medium serves to maintain an even and unaltered backlight since the LEDs get covered by the medium.

Materials A and B and X are the same ingredients as discussed above in the iPod Shuffle procedure except their relative ratios are different.

### Specific Example Embodiment #3

### Waterproofing Process Applied to Amazon® Kindle® Base Electronic Reader

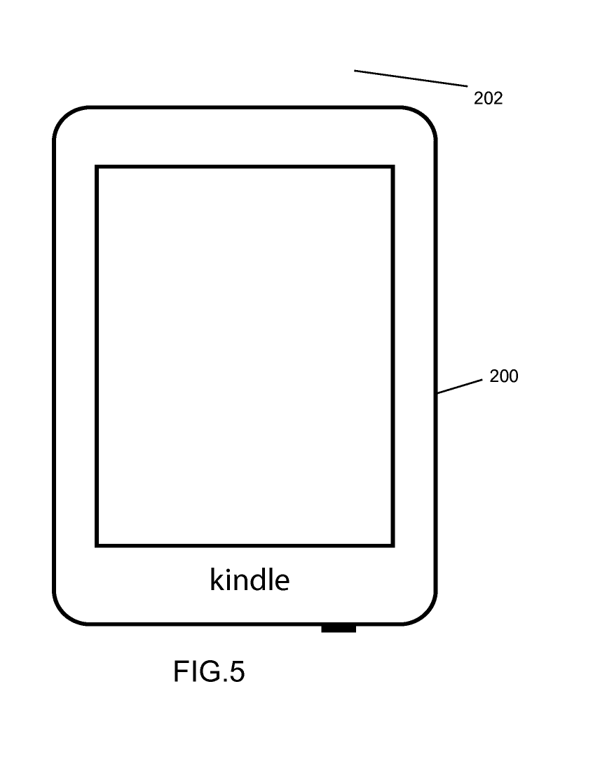

FIGS. 5 through 8 depict an Amazon® Kindle® electronic reader, such as a base model or other model, however, the general features are common to many electronic devices, not just readers: buttons of several different types, a bezel, apertures and so on. The term “Kindle” in the figure is a registered trademark not associated with the applicants. FIG. 5 is an overhead view of the electronic reader 200, with the bezel 202 in place.

The mixture described above for the Paperwhite model electronic reader available from Amazon may also be applied to the base or original model Kindle with the following modifications of the procedure:

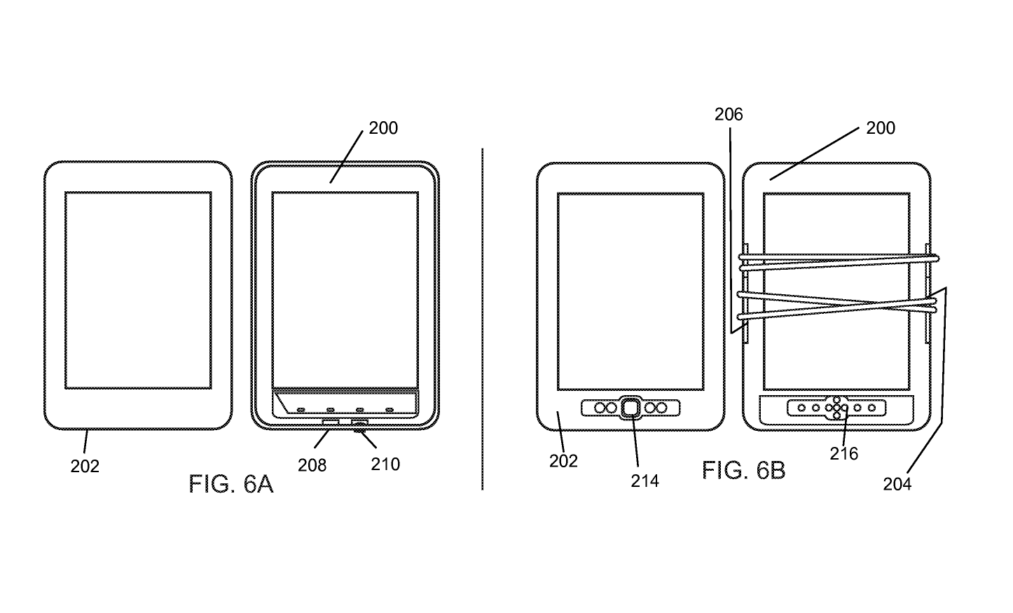

1. Remove bezel, keeping the rubber buttons with it. FIG. 6A is an overhead view of the bezel 202 removed from the electronic reader 200, that is, an exploded view. Visible at the bottom of the reader are micro-USB slot 208 and power button 210.

2. With bezel off, grease side buttons and bottom bezel buttons by filling the cavity 216 that the plastic buttons fit into while the actual plastic buttons stay with the bezel (214: buttons with bezel).

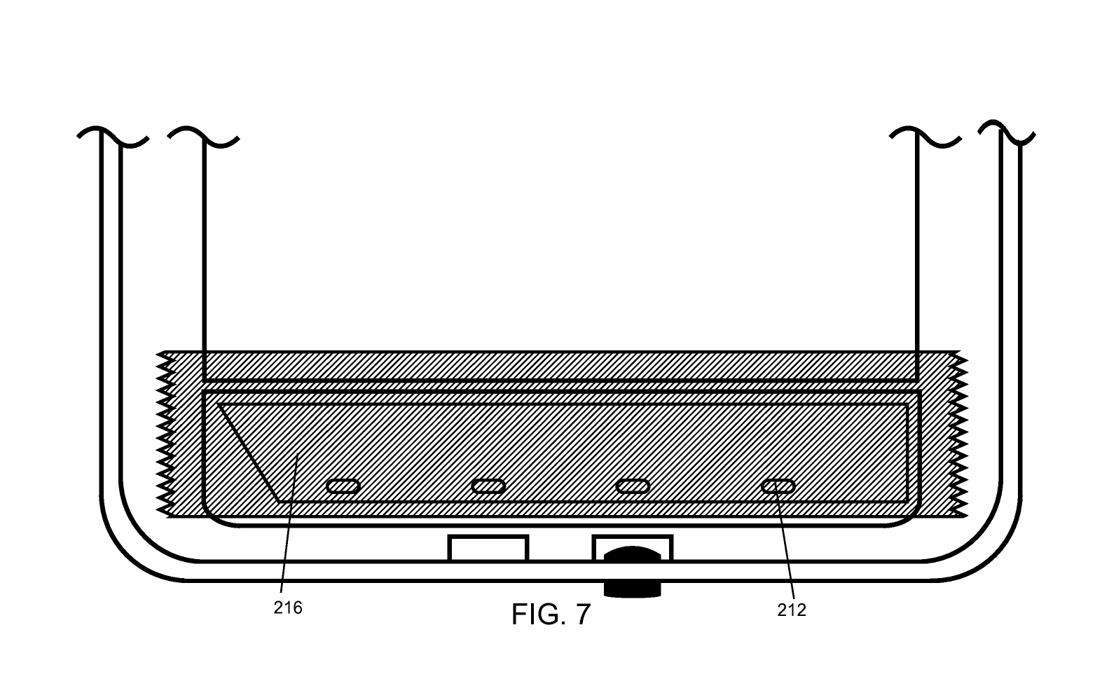

3. Cover the bezel button cavity area with scotch tape. FIG. 7 is a close-up view of tape 218 placed over the LED lights 212 of the electronic reader.

4. Grease the power button cavity 220.

5. Wrap elastic bands 204 around the side buttons so that they are fully depressed. FIG. 6B is an overhead view of the electronic reader 200 with the bezel 202 removed and with elastic bands 204 placed around the greased buttons 206 to hold them down and prevent them from becoming sticky.

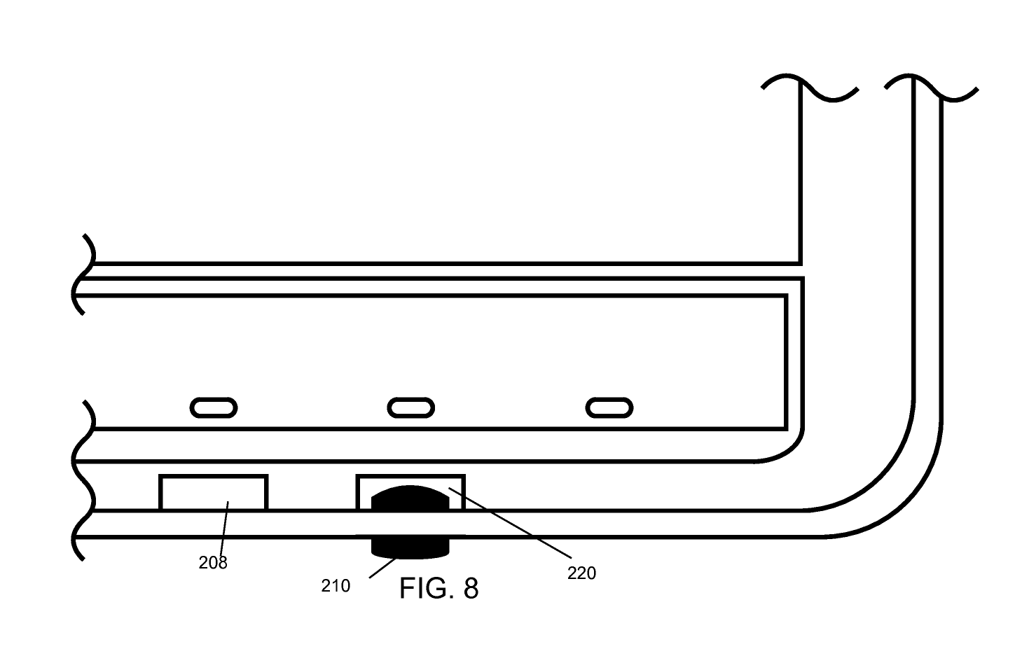

FIG. 8 is a close-up view of the cavity around the backside of the power button of the electronic reader, which must also be filled with waterproofing medium.

6. Fill the electronic reader with the waterproofing medium.

7. Grease the micro USB plug.

8. Insert the micro USB plug into Kindle's micro USB port.

9. Remove tape from the bezel buttons and remove the elastic bands.

10. Attach the buttons and bezel, making them flush with the sides of the Kindle body.

11. Clean off the electronic reader completely.

12. Press all of the buttons repeatedly to ensure substantially full movement and functionality of each button.

The base model Kindle includes several buttons (around 14) which should be greased on the inside similar to how the Paperwhite® power button is greased. Following greasing of the buttons, elastic bands should be placed around the side buttons, holding them down, before vacuuming the readers in step 6 above. This keeps the buttons from getting stiff. FIG. 6B illustrates the elastic bands holding down the side buttons of the base model electronic reader available under the brand name Kindle.

The present invention is not limited to the embodiments described above.

Various changes and modifications can, of course, be made, without departing from the scope and spirit of the present invention. Additional advantages and modifications will readily occur to those skilled in the art. Accordingly, various modifications may be made without departing from the spirit or scope of the general inventive concept as defined by the appended claims and their equivalents.

What is claimed is:

1. A method for waterproofing one or more electronic components within an electronic device, comprising:
placing the electronic device and the first hydrophobic medium together into a vacuum chamber;
sealing the vacuum chamber;
reducing pressure inside the vacuum chamber to below atmospheric pressure;
slowly letting air back inside the vacuum chamber; and
removing the electronic device from the first hydrophobic medium.

2. The method of claim 1, further comprising maintaining reduced pressure below atmospheric pressure inside the vacuum chamber until the appearance of the first hydrophobic medium bubbles signifying the release of air.

3. The method of claim 1, further comprising, prior to removing the electronic device from the first hydrophobic medium, stirring the first hydrophobic medium to release air, and one or more times prior to removing the electronic device repeating the steps of: sealing the vacuum chamber, reducing pressure inside the vacuum chamber to below atmospheric pressure, and, slowly letting air back inside the vacuum chamber.

4. The method of claim 1, further comprising placing the electronic device into a second medium of an anti-corrosive agent.

5. The method of claim 4, further comprising prior to placing the electronic device into a second medium of an anti-corrosive agent, inserting a cord into an externally accessible port of the electronic device thereby preserving functionality by clearing it out before the first hydrophobic medium cures and hardens.

6. The method of claim 5, further comprising after inserting the cord, placing the electronic device into a clamping device and pressing down on the buttons of the electronic device in one or more orientations while the cord is still inserted in the port.

7. The method of claim 1, wherein the first hydrophobic medium comprises silicone.

8. The method of claim 7, wherein the first hydrophobic medium further comprises a curing agent.

9. The method of claim 8, wherein the first hydrophobic medium further comprises an anti-corrosive agent.

10. The method of claim 9, wherein the first hydrophobic medium further comprises a coloring agent.

11. The method of claim 1, further comprising prior to covering the electronic device with the first hydrophobic medium, applying a strip of adhesive tape over one or more lights of the electronic device, applying grease to a power button of the electronic device while the lights are covered with the tape, and, removing the tape.

12. The method of claim 8, wherein the weight fraction of the silicone in the first hydrophobic medium is greater than the weight fraction of the curing agent.

13. The method of claim 9, wherein the weight fraction of the silicone in the first hydrophobic medium is greater than the weight fraction of the curing agent and the weight fraction of the curing agent in the first hydrophobic medium is greater than the weight fraction of the anti-corrosive agent.

14. The method of claim 7, wherein the first hydrophobic medium further comprises polyethylene (PE) pellets.

15. The method of claim 7, wherein the first hydrophobic medium further comprises polytetrafluoroethylene (PTFE) powder.

16. The method of claim 1, wherein the pressure inside the vacuum chamber is reduced to between 10 to 30 inches of Mercury below atmospheric pressure.

17. The method of claim 1, wherein the first hydrophobic medium enters an external housing of the electronic device to surround one or more electronic components therein internally to the housing.

18. The method of claim 17, wherein slowly letting air back inside the vacuum chamber pushes the first hydrophobic medium into the exterior housing of the electronic device.

19. The method of claim 17, wherein the electronic device is one member selected from the group consisting of a standard, pre-fabricated: portable music player, mobile phone, Smartphone, electronic reader, tablet computer, camera, fitness tracking device, medical data-gathering device, drug-dispensing device, research data-gathering device and combinations thereof.

20. The method of claim 4, wherein the electronic device is kept in the second medium of the anti-corrosive agent for 30 to 120 minutes.

21. The method of claim 4, wherein the first hydrophobic medium and the second anti-corrosive medium enter an external housing of the electronic device to surround one or more electronic components therein internally to the housing.

22. A waterproof electronic device comprising one or more electronic components waterproofed according to the method of claim 1.
